(19) United States
(12) Patent Application Publication
(10) Pub. No.: US 2023/0306539 A1
(43) Pub. Date: Sep. 28, 2023

(54) Computer Vision Systems and Methods for Property Scene Understanding from Digital Images and Videos

(71) Applicant: Insurance Services Office, Inc., Jersey City, NJ (US)

(72) Inventors: Matthew D. Frei, Lehi, UT (US); Samuel Warren, Salt Lake City, UT (US); Ravi Shankar, Fremont, CA (US); Devendra Mishra, Salt Lake City, UT (US); Mostapha Al-Saidi, Deerfield Beach, FL (US); Jared Dearth, Lehi, UT (US)

(73) Assignee: Insurance Services Office, Inc., Jersey City, NJ (US)

(21) Appl. No.: 18/127,414

(22) Filed: Mar. 28, 2023

Related U.S. Application Data
(60) Provisional application No. 63/324,350, filed on Mar. 28, 2022.

(51) Int. Cl. G06Q 50/16; G06V 20/10; G06T 7/246

(52) U.S. Cl. CPC G06Q 50/163; G06V 20/176; G06T 7/251; G06T 2207/20084

(57) ABSTRACT

Computer vision systems and methods for property scene understanding from digital images, videos, media and/or sensor information are provided. The system obtains media content indicative of an asset, performs feature segmentation and material recognition, performs object detection on the features, performs hazard detection to detect one or more safety hazards, and performs damage detection to detect any visible damage, to develop a better understanding of the property using one or more features in the media content. The system can output the feature segmentation and material detection, the hazard detection, the content feature detection, and the damage detection, and all other available models to an adjuster or other user on a user interface.

### RELATED APPLICATIONS

The present application claims the priority of U.S. Provisional Patent Application Ser. No. 63/324,350 filed on Mar. 28, 2022, the entire disclosure of which is expressly incorporated herein by reference.

### BACKGROUND

### Technical Field

The present disclosure relates generally to the field of computer vision. More specifically, the present disclosure relates to computer vision systems and methods for property scene understanding from digital images and videos.

### Related Art

Performing actions related to property understanding such as insurance policy adjustments, insurance quote calculations, underwriting, inspections, remodeling evaluations, claiming process and/or property appraisal involves an arduous and time-consuming manual process. For example, a human operator (e.g., a property inspector) often must physically go to a property site to inspect the property for a hazard, or risk, or property evaluation, or damage assessments to name a few. These operations involve multiple human operators and are cumbersome and prone to human error. Moreover, sending a human operator multiple times makes the process expensive as well. In some situations, the human operator may not be able to accurately and thoroughly capture all of the relevant items (e.g., furniture, appliances, doors, floors, walls, structure faces, roof structure, trees, pools, decks, etc.), or properly recognize materials, hazards, and damages, which may result in inaccurate assessment and human bias errors. Further, the above processes can sometimes place the human operator in dangerous situations, when the human operator approaches an area (e.g., a damaged roof, an unfenced pool, dead trees, or the like).

Thus, what would be desirable are automated computer vision systems and methods for property scene understanding from digital images, videos, media content and/or sensor information which address the foregoing, and other, needs.

### SUMMARY

The present disclosure relates to computer vision systems and methods for property scene understanding from digital images, videos, media and/or sensor information. The system obtains media content (e.g., a digital image, a video, a video frame, a sensory information, or other type of content) indicative of an asset (e.g., a real estate property). The system provides a holistic overview of the property, such as performs feature segmentation (e.g., walls, doors, floors, etc.) and material recognition (e.g., wood, ceramic, laminate, or the like), performs object detection on the items (e.g. sofa, TV, refrigerator, or the like) found inside the house, performs hazard detection (e.g. damaged roof, missing roof singles, unfenced pool, or the like) to detect one or more safety hazards, perform damage detection to detect any visible damage (e.g. water damage, wall damage, or the like) to the property or any such operation to develop a better understanding of the property using one or more features in the media content. The system can run any of the available models, for example, the system can determine one or more features in the media content using one or more model types such as Object Detection, Segmentation and/or Classification, or the like. The system can also perform a content feature detection on one or more content features in the media content. The system can select bounding boxes with a confidence score using a predetermined threshold and retain the bounding boxes that have a confidence score above a predetermined threshold value. The system can also select pixels or groups of pixels pertaining to one class and assign a confidence value. The system can also perform hazard detection (e.g., a roof damage, a roof missing shingle, a roof trap, an unfenced pool, a pool slide, a pool diving board, yard debris, tree touching structure, a dead tree, or the like) on the one or more features in the media content. The system performs a damage detection on the one or more features in the media content. In some embodiments, the system can further determine a severity level and a priority level of the detected damage. It should be understood that the system can be expanded by adding other computer vision models, and such models can work in conjunction with each other to further the understanding of the property. The system presents outputs of the feature segmentation and material detection, the hazard detection, the content feature detection, and the damage detection, and all other available models to the adjuster or other user on a user interface. In some embodiments, the system can receive a feedback associated with an actual output after applying the trained computer vision model to a different asset or different media content. The feedback received from the user can be further used to fine-tune the trained computer vision and improve performance.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating an embodiment of the system of the present disclosure;

FIG. 2 is a flowchart illustrating overall processing steps carried out by the system of the present disclosure;

FIG. 3 is a diagram illustrating feature segmentation and material detection process performed by the system of the present disclosure;

FIG. 4 is a diagram illustrating a feature detection process performed by the system of the present disclosure;

FIG. 5 is a diagram illustrating an example hazard detection process performed by the system of the present disclosure;

FIG. 6 is a diagram illustrating an example damage detection process performed by the system of the present disclosure;

FIG. 7 is a diagram illustrating an example comprehensive detection process performed by the system of the present disclosure;

FIG. 8 is a diagram illustrating training steps carried out by the system of the present disclosure; and

FIG. 9 is a diagram illustrating hardware and software components capable of being utilized to implement the system of the present disclosure.

### DETAILED DESCRIPTION

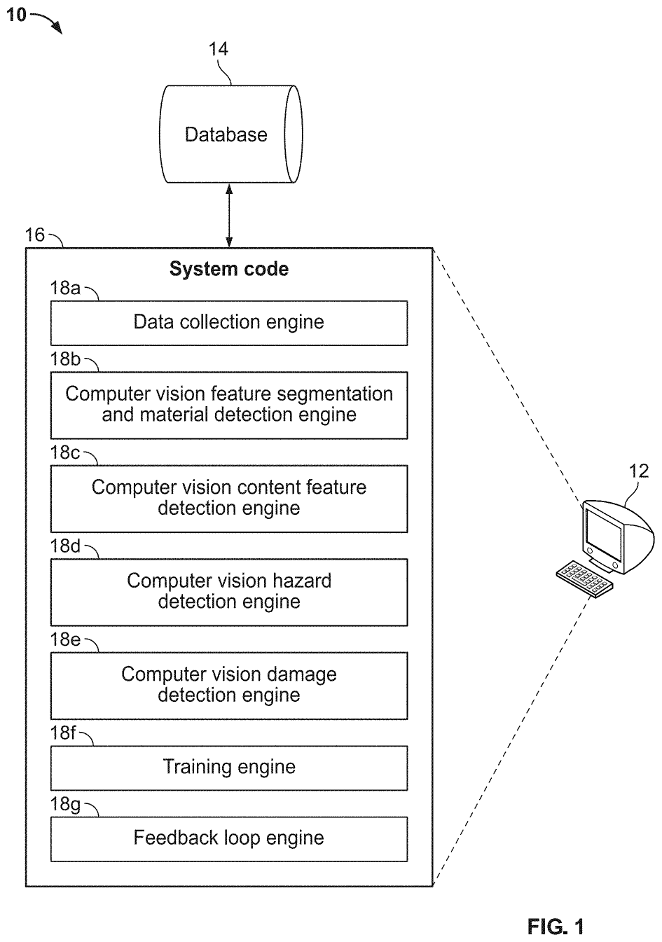

The present disclosure relates to computer vision systems and methods for property scene understanding from digital image, videos, media and/or sensor information as described in detail below in connection with FIGS. 1-9.

Turning to the drawings, FIG. 1 is a diagram illustrating an embodiment of the system 10 of the present disclosure. The system 10 can be embodied as a central processing unit 12 (processor) in communication with a database 14. The processor 12 can include, but is not limited to, a computer system, a server, a personal computer, a cloud computing device, a smart phone, or any other suitable device programmed to carry out the processes disclosed herein. The system 10 can retrieve data from the database 14 associated with an asset.

An asset can be a resource insured and/or owned by a person or a company. Examples of an asset can include a real estate property (e.g., residential properties such as a home, a house, a condo, an apartment, and commercial properties such as a company site, a commercial building, a retail store, etc.), a vehicle, or any other suitable properties. An asset can have specific features such as interior features (e.g., features appearing within a structure/building) and exterior features (e.g., features appearing on the exterior of a building or outside on a property). While the present disclosure has been described in connection with properties, it is to be understood that features of other assets such as vehicles could be detected and processed by the systems and method disclosed herein, such as vehicle damage, etc. On examine of a system for detecting vehicle damage that could be utilized with the systems and methods of the present disclosure include the systems/methods disclosed in U.S. Patent Application Publication No. US2020/0034958, the entire disclosure of which is expressly incorporated herein.

Examples of interior features include general layout (e.g., floor, interior wall, ceiling, door, window, stairs, etc.), furniture, molding/trim features (e.g., baseboard, door molding, window molding, window stool and apron, etc.), lighting features (e.g., ceiling fans, light fixture, wall lighting, etc.), heating, ventilation, and air conditioning (HVAC) features (e.g., furnace, heater, air conditioning, condenser, thermostat, fireplace, ventilation fan, etc.), plumbing features (e.g., valve, toilet, sink, tub, shower faucet, plumbing pipes, etc.), cabinetry/shelving/countertop features (e.g., cabinetry, shelving, mantel, countertop, etc.), appliances (e.g., refrigerator, dishwasher, dyer, washing machine, oven, microwave, freezer, etc.), electric features (e.g., outlet, light switch, smoke detector, circuit breaker, etc.), accessories (e.g., door knob, bar, shutters, mirror, holder, organizer, blinds, rods, etc.), and any suitable features.

Examples of exterior features include an exterior wall structure, a roof structure, an outdoor structure, a garage door, a fence structure, a window structure, a deck structure, a pool structure, yard debris, tree touching structure, plants, exterior gutters, exterior pipes, exterior vents, exterior HVAC features, exterior window and door trims, exterior furniture, exterior electric features (e.g., solar panel, water heater, circuit breaker, antenna, etc.), accessories (e.g., door lockset, exterior light fixture, door bells, etc.), and any features outside the asset.

The database 14 can include various types of data including, but not limited to, media content indicative of an asset as described below, one or more outputs from various components of the system 10 (e.g., outputs from a data collection engine 18a, a computer vision feature segmentation and material detection engine 18b, a computer vision content feature detection engine 18c, a computer vision hazard detection 18d, a computer vision damage detection engine 18e, a training engine 18f, and a feedback loop engine 18g, and/or other components of the system 10), one or more untrained and trained computer vision models, one or more untrained and trained feature extractors and classification models, one or more untrained and trained segmentation models, one or more training data collection models and associated training data. The system 10 includes system code 16 (non-transitory, computer-readable instructions) stored on a computer-readable medium and executable by the hardware processor 12 or one or more computer systems. The system code 16 can include various custom-written software modules that carry out the steps/processes discussed herein, and can include, but is not limited to, the data collection engine 18a, the computer vision feature segmentation and material detection engine 18b, the computer vision content feature detection engine 18c, the computer vision hazard detection engine 18d, the computer vision damage detection engine 18e, the training engine 18f, and the feedback loop engine 18g. The system code 16 can be programmed using any suitable programming languages including, but not limited to, C, C++, C#, Java, Python, or any other suitable language. Additionally, the system code 16 can be distributed across multiple computer systems in communication with each other over a communications network, and/or stored and executed on a cloud computing platform and remotely accessed by a computer system in communication with the cloud platform. The system can also be deployed on the device such as a mobile phone or the like. The system code 16 can communicate with the database 14, which can be stored on the same computer system as the code 16, or on one or more other computer systems in communication with the code 16

The media content can include digital images, digital videos, and/or digital image/video datasets including ground images, aerial images, satellite images, etc. where the digital images and/or digital image datasets could include, but are not limited to, images of the asset. Additionally and/or alternatively, the media content can include videos of the asset, and/or frames of videos of asset. The media content can also include one or more three dimensional (3D) representations of the asset (including interior and exterior structure items), such as point clouds, light detection and ranging (LiDAR) files, etc., and the system 10 could retrieve such 3D representations from the database 14 and operate with these 3D representations. Additionally, the system 10 could generate 3D representations of the asset, such as point clouds, LiDAR files, etc. based on the digital images and/or digital image datasets. As such, by the terms “imagery” and “image” as used herein, it is meant not only 3D imagery and computer-generated imagery, including, but not limited to, LiDAR, point clouds, 3D images, etc., but also optical imagery (including aerial and satellite imagery).

Still further, the system 10 can be embodied as a customized hardware component such as a field-programmable gate array (“FPGA”), an application-specific integrated circuit (“ASIC”), embedded system, or other customized hardware components without departing from the spirit or scope of the present disclosure. It should be understood that FIG. 1 is only one potential configuration, and the system 10 of the present disclosure can be implemented using a number of different configurations.

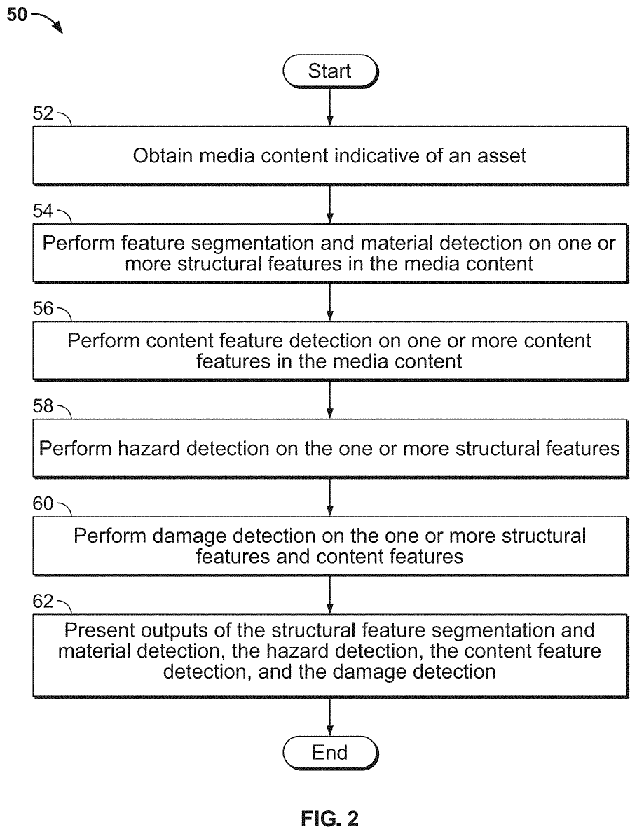

FIG. 2 is a flowchart illustrating overall processing steps 50 carried out by the system 10 of the present disclosure. Beginning in step 52, the system 10 obtains media content indicative of an asset. As mentioned above, the media content can include imagery data and/or video data of an asset, such as an image of the asset, a video of the asset, a 3D representation of the asset, or the like. The system 10 can obtain the media content from the database 14. Additionally and/or alternatively, the system 10 can instruct an image capture device (e.g., a digital camera, a video camera, a LiDAR device, an unmanned aerial vehicle (UAV) or the like) to capture a digital image, a video, or a 3D representation of the asset. In some embodiments, the system 10 can include the image capture device. Alternatively, the system 10 can communicate with a remote image capture device. It should be understood that the system 10 can perform the aforementioned task of obtaining the media content via the data collection engine 18a.

In step 54, the system 10 performs feature segmentation and material detection on one or more features in the media content. For example, the system 10 can determine one or more features in the media content using one or more model capable of localizing output in bounding box, mask or polygon format and/or one or more classification models to detect the material or attribute. A segmentation model can utilize one or more image segmentation techniques and/or algorithms, such as region-based segmentation that separates the media content into different regions based on threshold values, an edge detection segmentation that utilizes discontinuous local features of the media content to detect edges and hence define a boundary of an item, clustering segmentation that divides pixels of the media content into different clusters (e.g., K-means clustering or the like), each cluster corresponding to a particular area, machine/deep-learning-based segmentation that perform segmentation to determine that estimates probabilities that each point/pixel of the media content belongs to a class (e.g., convolutional neural network (CNN) based segmentation, such as regions with CNN (R-CNN) based segmentation, fully convolutional network (FCN) based segmentation, weakly Supervised based segmentation, AlexNet based segmentation, VGG-16 based segmentation, GoogLeNet based segmentation, ResNet based segmentation, or the like), or some combination thereof. A classification model can place or identify a segmented feature as belonging to a particular item classification. The classification model can be a machine/deep-learning-based classifier, such as CNN based classifier (e.g., ResNet based classifier, AlexNet based classifier, VGG-16 based classifier, GoogLeNet based classifier, or the like), a supervised machine learning based classifier, an unsupervised machine learning based classifier, or some combination thereof. The classification model can include one or more binary classifiers, and/or one or more multi-class classifier or a combination. In some examples, the classification model can include a single classifier to identify each region of interest or ROI. In another examples, the classification model can include multiple classifiers each analyzing a particular area. In some embodiments, the one or more segmentation models and/or one or more classification models and/or other model type are part of a single computer vision model. For example, the one or more segmentation models and/or one or more classification models are sub-models and/or sub-layers of the computer vision model. In some embodiments, the system 10 can include the one or more segmentation models and/or one or more classification models, and other computer vision models. For example, outputs of the one or more segmentation models and/or one or more classification models are inputs to the other computer vision models for further processing.

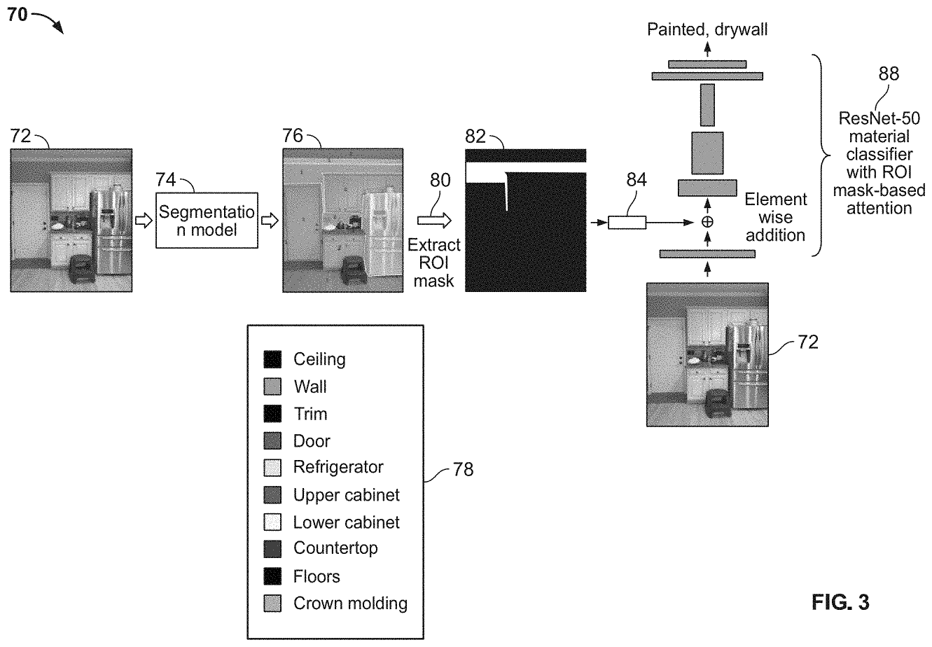

In some embodiments, the feature segmentation and material detection can be carried out using any of the processes described in co-pending U.S. Application Ser. No. 63/289,726, the entire disclosure of which is expressly incorporated herein by reference. For example, as shown in FIG. 3 (which is a diagram illustrating an example item segmentation and material detection process performed by the system of the present disclosure), an image 72 of an interior property (e.g., a kitchen) is captured and is segmented by a segmentation model 74 into a segmented image 76. The segmented image 76 is an overlay image in which the image 72 is overlaid with a colored mask image, and each color corresponds to a particular item shown in a legend 78. The colored mask image assigns a particular-colored mask/class indicative of a particular item to each pixel of the image 72. Pixels from the particular item have the same color. Additionally and/or alternatively, a segmentation model can include one or more classifiers to identify the attribute or material of one or more items. Examples of classifiers are described above with respect to classification models. A mask 82 for a region of interest (ROI) corresponding to a wall is extracted in step 80. The mask 82 is generated by the segmentation model 74. The mask 82 corresponding to the item and the image 72 are combined as input to the ResNet-50 material classifier 88. The ResNet-50 material classifier 88 outputs an indication (e.g., drywall) of the material or attribute identified from the combination of the image and the mask. It should be understood that the system 10 can perform the aforementioned tasks via the computer vision fsegmentation and material detection engine 18b.

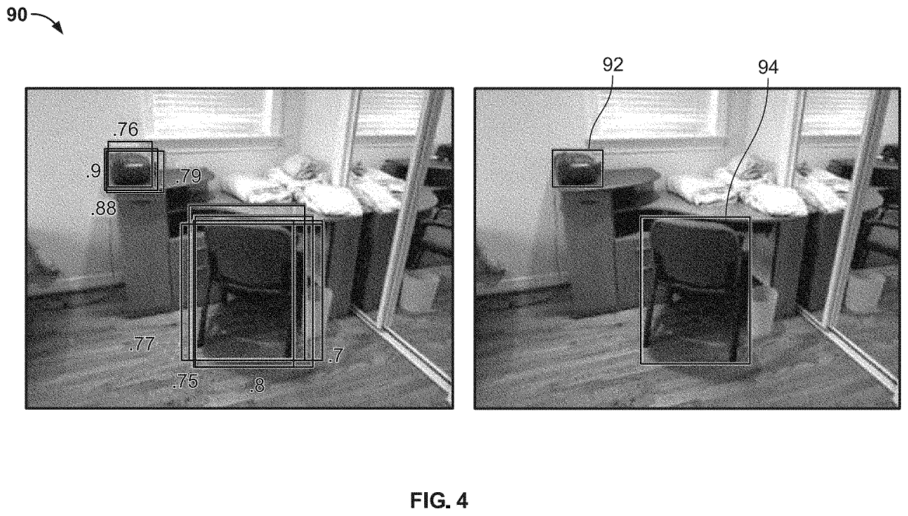

In step 56, the system 10 performs feature detection on one or more content features in the media content. In some embodiments, the content detection can be carried out using any of the processes described in co-pending U.S. application Ser. No. 17/162,755, the entire disclosure of which is expressly incorporated herein by reference. For example, as shown in FIG. 4 (which is a diagram illustrating an example content feature detection process 90 performed by the system of the present disclosure), the system 10 can select bounding boxes with a confidence score over a predetermined threshold. The system 10 can determine a confidence level for each of the bounding boxes (e.g., a proposed detection of an object). The system 10 will keep the bounding boxes that have a confidence score above a predetermined threshold value. For example, bounding boxes with a confidence score of 0.7 or higher are kept and bounding boxes with a confidence score below or equal to 0.7 can be discarded. In an example, several overlapping bounding boxes can remain. For example, multiple output bounding boxes can produce roughly the same proposed object detection. In such an example, a non-maximal suppression method can be used to select a single proposed detection (e.g., a single bounding box). In an example, an algorithm is used to select the bounding box with the highest confidence score in a neighborhood of each bounding box. The size of the neighborhood is a parameter of the algorithm and can be set, for example, to a fifty percent overlap. For example, as shown in FIG. 4, a bounding box 92 having a confidence score greater than 0.8 and a bounding box 94 having a confidence score equal to 0.8 are selected. The system 10 can further identify a radio corresponding to the bounding box 92 and a chair corresponding to the bounding box 94.

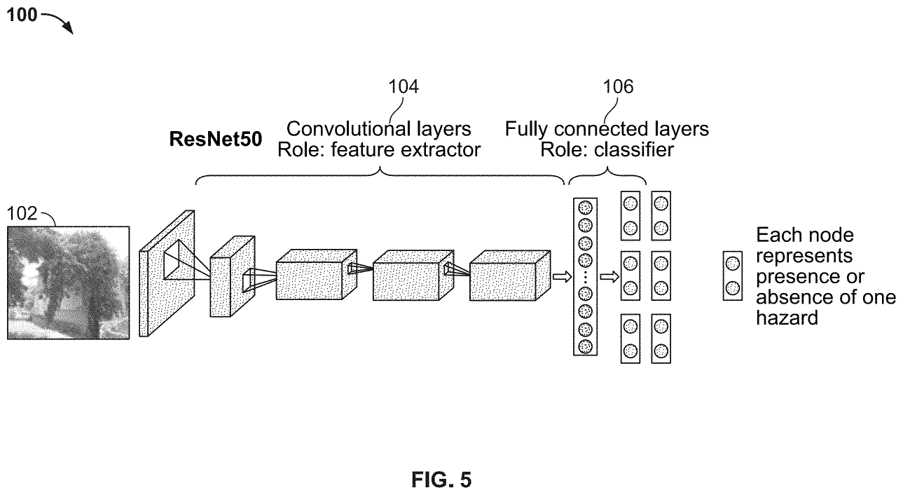

In step 58, the system 10 performs hazard detection on the one or more features detected during training by the computer vision model. For example, the system 10 can identify one or more hazards in the media asset. Examples of a hazard can include a roof damage, a roof missing shingle, a roof trap, an unfenced pool, a pool slide, a pool diving board, yard debris, tree touching structure, a dead tree, or the like. In some embodiments, the hazard detection can be carried out using any of the processes described in co-pending U.S. Application Ser. No. 63/323,212, the entire disclosure of which is expressly incorporated herein by reference. For example, as shown in FIG. 5 (which is a diagram illustrating an example hazard detection process performed by the system of the present disclosure), a hazard detection model 100 can be part of the computer vision model as mentioned above or can include one or more computer vision models (e.g., a ResNet 50 computer vision model). The hazard detection model 100 includes a feature extractor 104 and a classifier 106. The feature extractor 104 includes multiple conventional layers. The classifier 106 includes fully connected layers having multiple nodes. Each output node can represent a presence or an absence of a hazard for an area or image. An image 102 showing a house and trees surrounding the house is an input of the hazard detection model 100. The feature extractor 84 extracts one or more from the image 102 via the convolutional layers. The one or more extracted features are inputs to the classifier 106 and are processed via the nodes of the classifier 106. The classifier 106 outputs one or more hazards (e.g., tree touching structure) that are most likely to be present in the extracted feature. In some embodiments, the step 54 can include the feature extractor 104 to extract features. In some embodiments, the computer vision model can just do classification to identify if a a hazard is present in the media asset. In another embodiments, the computer vision model and identify the region in colored pixels using segmentation models. It should be understood that the system 10 can perform the aforementioned tasks via the computer vision hazard detection engine 18d.

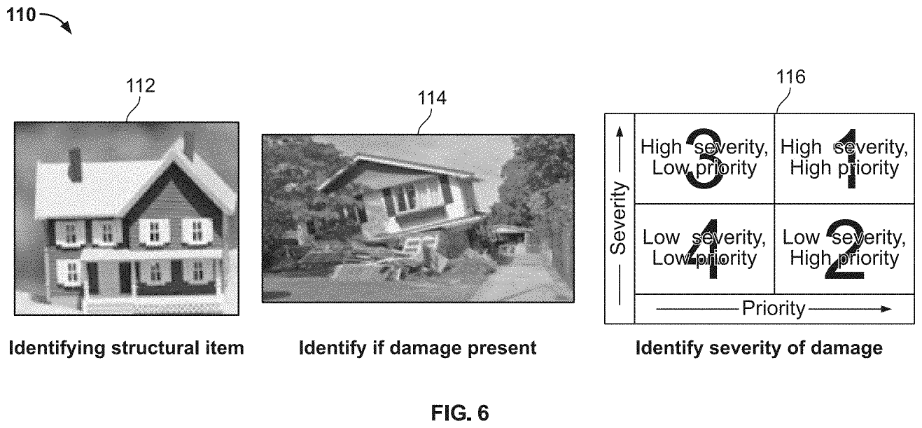

In step 58, the system 10 performs damage detection on the one or more content or items. In some embodiments, the system 10 can further determine a severity level of the detected damage. In some embodiments, the system 10 can further estimate cost for repairing and/or replacing objects having the damaged features. For example, as shown in FIG. 6 (which is a diagram illustrating an example damage detection process performed by the system of the present disclosure), the system 10 can identify 112 one or more items in a house. The system 10 can further determine 114 whether the identified items are damaged, and determine a damage type associated with the identified damage. The system 10 can further determine 116 a severity level (e.g., high severity, low severity, or the like associated with the identified damage. It should be understood that the system 10 can perform the aforementioned tasks via the computer vision damage detection engine 18e.

In step 62, the system 10 presents outputs of the segmentation and material or attribute detection, the hazard detection, the content detection, the damage detection, or other models. For example, the system 10 can generate various indications associated the above detections. In some embodiments the system 10 can present a graphical user interface including the generated indications, each indication indicating an output of a particular detection. It should be understood that the system 10 can perform the aforementioned task via the computer vision segmentation and material detection engine 18b, the computer vision content detection engine 18c, the computer vision hazard detection engine 18d, and/or the computer vision damage detection engine 18e. [add generic computer vision encompassing all future models]

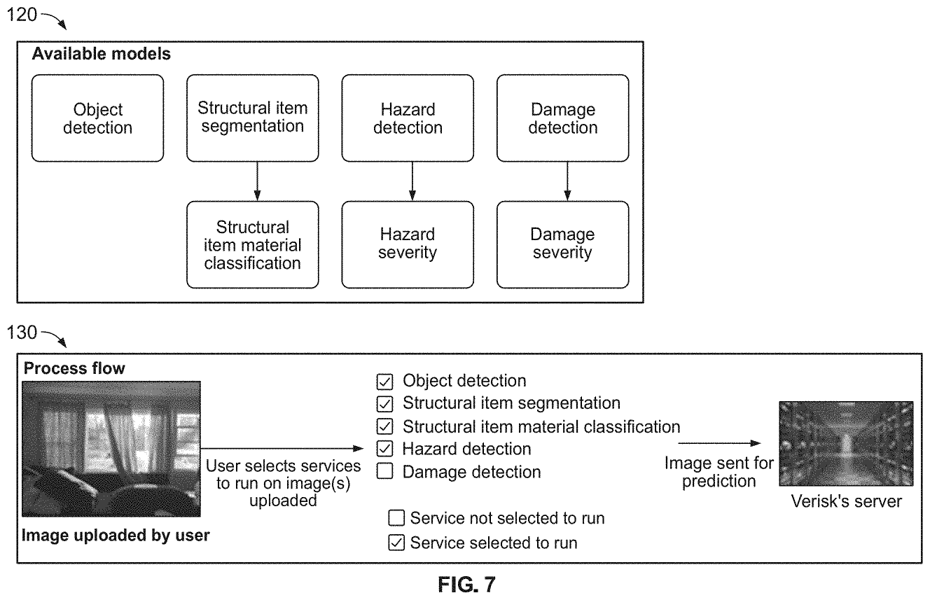

FIG. 7 is a diagram illustrating an example comprehensive detection process performed by the system of the present disclosure. As shown in FIG. 7, the system 10 can include various models 120 to perform a classification or localization or a combination of the two for tasks such as content detection, area segmentation, material or attribute classification, a hazard detection, a hazard severity, a damage detection and a damage severity, or the like. The system 10 can also perform an example process flow 130. For example, an image can be uploaded tstem 10 by a user. The user can also select (“toggle”) the detection services to be run on the uploaded image. As shown in FIG. 7, the user selected the object detection, the item segmentation, the item material classification, the hazard detection. The system 10 receives the selected detections and the uploaded image, and the system 10 performs the selected detections on the image.

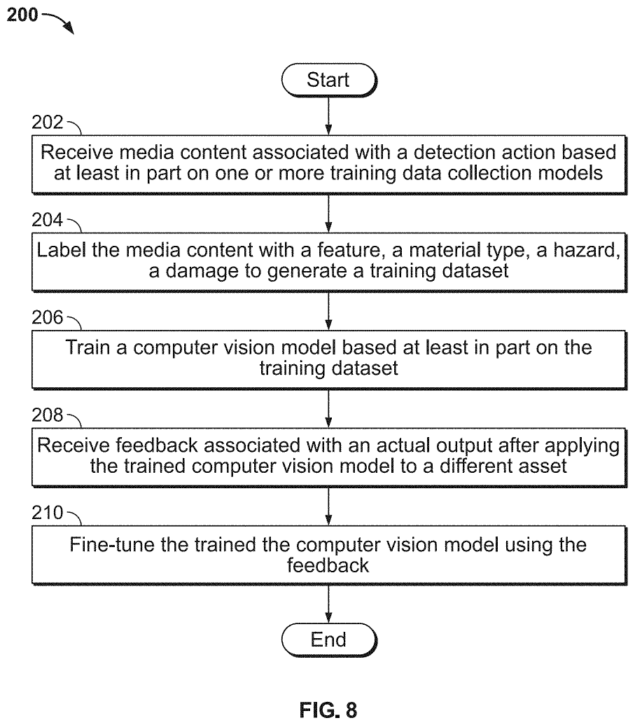

FIG. 8 is a diagram illustrating training steps 200 carried out by the system 10 of the present disclosure. Beginning in step 202, the system 10 receives media content (e.g., one or more images/videos, a collection of images/videos, or the like) associated with a detection action based at least in part on one more training data collection models. A training data collection model can determine media content that is most likely to include or that include a particular item and material or attribute type, content item, a hazard, and a damage. Example of a training data collection model can include a text-based search model, a neural network model, a contrastive learning based model, any suitable models to generate/retrieve the media content, or some combination thereof. It should be understood that the system 10 can perform one or more of the aforementioned preprocessing steps in any particular order via the training engine 18f.

In step 124, the system 10 labels the media content with a feature, a material type, a hazard, and a damage to generate a training dataset. For example, the system 10 can generate an indication indicative of the feature, the material type, the hazard, and the damage associated with each image of the media content. In some examples, the system 10 can present the indication directly on the media content or adjacent to the media content. Additionally and/or alternatively, the system 10 can generate metadata indicative of the feature, the material type, the hazard, and the damage of the media content, and combine the metadata with the media content. The training data can include any sampled data including positive or negative. The training data can include labeled media content having a particular item, a material or attribute type, a hazard, and a damage to generate a training dataset. The training data can include media content that do not include the particular item, the material or attribute type, the hazard, and the damage.

In step 206, the system 10 trains a computer vision model based at least in part on the training dataset. In some embodiments, the computer vision model can be a single model that perform the above detections. In some embodiments, the computer vision model can include multiple sub-models, and each sub-model can perform a particular detection as mentioned above. In some embodiments, the system 10 can adjust one or more setting parameters (e.g., weights, or the like) of the computer vision model and/or one or more sub-models of the computer vision model using the training dataset to minimize an error between a generated output and an expected output of the computer vision model. In some examples, during the training process, the system 10 can generate threshold value for the particular feature/area, the material type, the hazard, and the damage to be identified.

In step 208, the system 10 receives feedback associated with an actual output after applying the trained computer vision model to a different asset or different media content. For example, a user can provide feedback if there is any discrepancy in the predictions.

In step 210 the system 10 fine-tunes the trained computer vision model using the feedback. For instance, data associated with the feedback can be used to adjust setting parameters of the computer vision model, and can be added to the training dataset to increase an accuracy or performance of model predictions. In some examples, a roof was previously determined to have “missing shingles” hazard. A feedback measurement indicates that the roof actually has a “roof damage” hazard and “missing shingles” was incorrectly predicted. The system 10 can adjust (e.g., decreasing) weight to weaken the correlation between the roof and the “missing shingles”. Similarly, the actual output can be used to adjust (e.g., decreasing or increasing) weight to adjust (e.g., weaken or enhance) the correlation between a feature/area and the previous predicted result. It should be understood that the system 10 can perform the aforementioned task of training steps via the training engine 18f, and the system 10 can perform the aforementioned task of feedback via the feedback loop engine 18g.

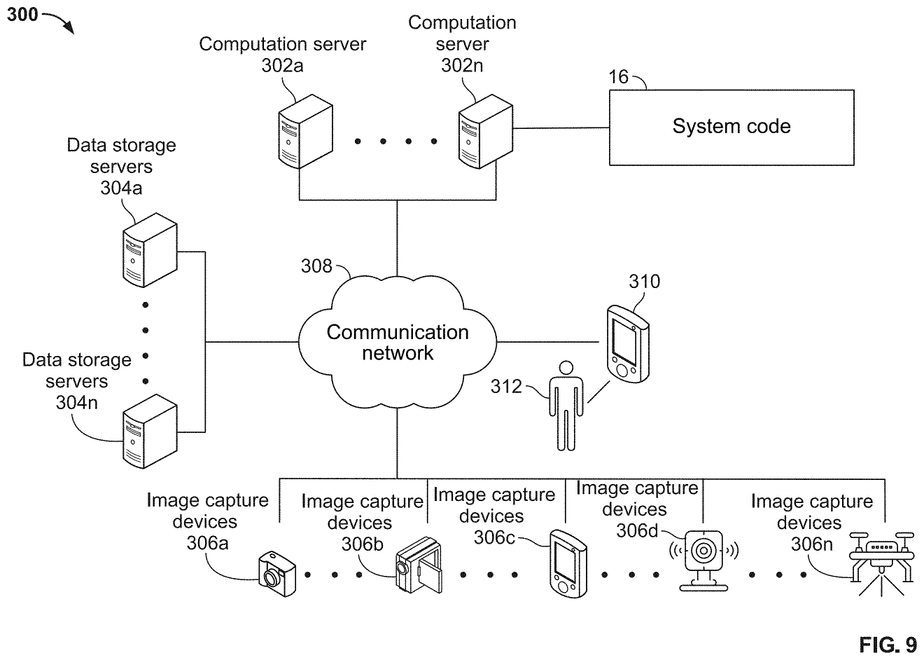

FIG. 9 illustrates a diagram illustrating another embodiment of the system 300 of the present disclosure. In particular, FIG. 9 illustrates additional computer hardware and network components on which the system 300 can be implemented. The system 300 can include a plurality of computation servers 302a-302n having at least one processor and memory for executing the computer instructions and methods described above (which can be embodied as system code 16). The system 300 can also include a plurality of data storage servers 304a-304n for receiving image data and/or video data. The system 300 can also include a plurality of image capture devices 306a-306n for capturing image data and/or video data. For example, the image capture devices can include, but are not limited to, a digital camera 306a, a digital video camera 306b, a use device having cameras 306c, a LiDAR sensor 306d, and a UAV 306n. A user device 310 can include, but it not limited to, a laptop, a smart telephone, and a tablet to capture an image of an asset, display an identification of a item and a corresponding material type to a user 312, and/or to provide feedback for fine-tuning the models. The computation servers 302a-302n, the data storage servers 304a-304n, the image capture devices 306a-306n, and the user device 310 can communicate over a communication network 308. Of course, the system 300 need not be implemented on multiple devices, and indeed, the system 300 can be implemented on a single (e.g., a personal computer, server, mobile computer, smart phone, etc.) without departing from the spirit or scope of the present disclosure.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A computer vision system for property scene understanding, comprising:
a memory storing media content indicative of an asset; and
a processor in communication with the memory, the processor programmed to:
obtain the media content;
segmenting the media content to detect and classify a feature in the media content corresponding to the asset;
process the media content to detect a hazard associated with the feature;
process the media content to detect damage associated with the feature; and
generate an output indicating the feature, the hazard associated with the feature, and the damage associated with the feature.

2. The computer vision system of claim 1, wherein the processor segments the media content using a segmentation model.

3. The computer vision system of claim 2, wherein the feature comprises a structural feature and the media content is segmented using a segmentation model that detects the structural feature.

4. The computer vision system of claim 2, wherein the segmentation model comprises one or more feature extraction neural network layers and one or more classifier neural network layers.

5. The computer vision system of claim 1, wherein the processor processes the media content to detect a material associated with the feature.

6. The computer vision system of claim 5, wherein the processor detects the material associated with the feature using a material classification model.

7. The computer vision system of claim 6, wherein the material classification model is a region-of-interest (ROI) masked-based attention model.

8. The computer vision system of claim 1, wherein the feature comprises a structural feature of the asset, and the processor classifies material corresponding to the structural item.

9. The computer vision system of claim 1, wherein the processor calculates a hazard severity corresponding to the hazard associated with the asset.

10. The computer vision system of claim 1, wherein the processor calculates a damage severity corresponding to the damage associated with the asset.

11. The computer vision system of claim 1, wherein the processor is trained using one or more training data collection models.

12. A computer vision method for property scene understanding, comprising the steps of:
retrieving by a processor media content corresponding to an asset and stored in a memory in communication with the processor;
segmenting the media content to detect and classify a feature in the media content corresponding to the asset;
process the media content to detect a hazard associated with the feature;
process the media content to detect damage associated with the feature; and
generate an output indicating the feature, the hazard associated with the feature, and the damage associated with the feature.

13. The method of claim 12, further comprising segmenting the media content using a segmentation model.

14. The method of claim 13, wherein the feature comprises a structural feature and the media content is segmented using a segmentation model that detects the structural feature.

15. The method of claim 14, wherein the segmentation model comprises one or more feature extraction neural network layers and one or more classifier neural network layers.

16. The method of claim 12, further comprising processing the media content to detect a material associated with the feature.

17. The method of claim 16, further comprising detecting the material associated with the feature using a material classification model.

18. The method of claim 17, wherein the material classification model is a region-of-interest (ROI) masked-based attention model.

19. The method of claim 12, wherein the feature comprises a structural feature of the asset, and further comprising classifying material corresponding to the structural item.

20. The method of claim 12, further comprising calculating a hazard severity corresponding to the hazard associated with the asset.

21. The method of claim 12, further comprising calculating a damage severity corresponding to the damage associated with the asset.

22. The method of claim 12, further comprising training the processor using one or more training data collection models.
